(19) United States
(12) Patent Application Publication
(10) Pub. No.: US 2016/0093924 A1
(43) Pub. Date: Mar. 31, 2016

(54) COMMUNICATION-CONNECTED BATTERY WITH EXPANSION CAPABILITY

(71) Applicant: Zlick, Inc., San Carlos, CA (US)

(72) Inventors: Roel Peeters, San Carlos, CA (US); James Blackwell, Los Gatos, CA (US)

(21) Appl. No.: 14/501,019

(22) Filed: Sep. 29, 2014

(51) Int. Cl. H01M 10/42

(52) U.S. Cl. CPC H01M 10/4257

(57) ABSTRACT

A sensor element includes mechanical connectors adapted to couple to conventional battery electrical terminals to provide mechanical support for the sensor on a battery housing or device, at least one sensing element that is capable of emitting an electrical signal upon sensing an sensed environmental variable, and an electrical connector, distinct from the mechanical connectors for receiving power from, and sending signals to, the battery housing or device. The coupled unit can be used to provide powered sensing and communication capability. The coupled unit's outputs could be processed with user presence information.

### FIELD

The present invention relates generally to adding communications capability and expansion onto sensors coupled with batteries.

### BACKGROUND

Compact sensors have many uses, such as door, state, temperature, acceleration, etc., sensors that might be inexpensively deployed, perhaps in a communications network. Typically, some sensors require some processing, communications capability and a power source to be nearby the sensor. However, some implementations might be too costly and/or too bulky.

### SUMMARY

A battery casing having internal power and processing capability and be used as part of a sensor by coupling a sensor tab onto the battery's casing such that power is supplied to the sensor and mechanical connection is provided between the two.

The following detailed description together with the accompanying drawings will provide a better understanding of the nature and advantages of the present invention.

### BRIEF DESCRIPTION OF THE DRAWINGS

FIG. 1 illustrates a battery casing as might be used in examples herein.

FIG. 2 is a top view of the battery casing of FIG. 1.

FIG. 3 illustrates an expansion tab that can be coupled to the battery casing.

FIG. 4 shows a battery casing and expansion tab coupled.

FIG. 5 illustrates daisy-chainable expansion tabs.

FIG. 6 illustrates various alternate form factors for battery casings.

### DETAILED DESCRIPTION

For purposes of explanation, specific configurations and details are set forth in order to provide a thorough understanding of the embodiments. However, it will also be apparent to one skilled in the art that the embodiments may be practiced without the specific details.

Furthermore, well-known features may be omitted or simplified in order not to obscure the embodiment being described.

In embodiments of devices explained herein, a battery casing that combines a power source and processing and/or communications capability into a particular form factor, can be used with expansion tabs to provide a compact, powered sensor device that can communicate with other devices. Examples of such battery casings might be those described in U.S. patent application Ser. No. ______ (Attorney Docket 0100684-001US0; filed concurrently with the present application). That application is incorporated by reference herein for all purposes.

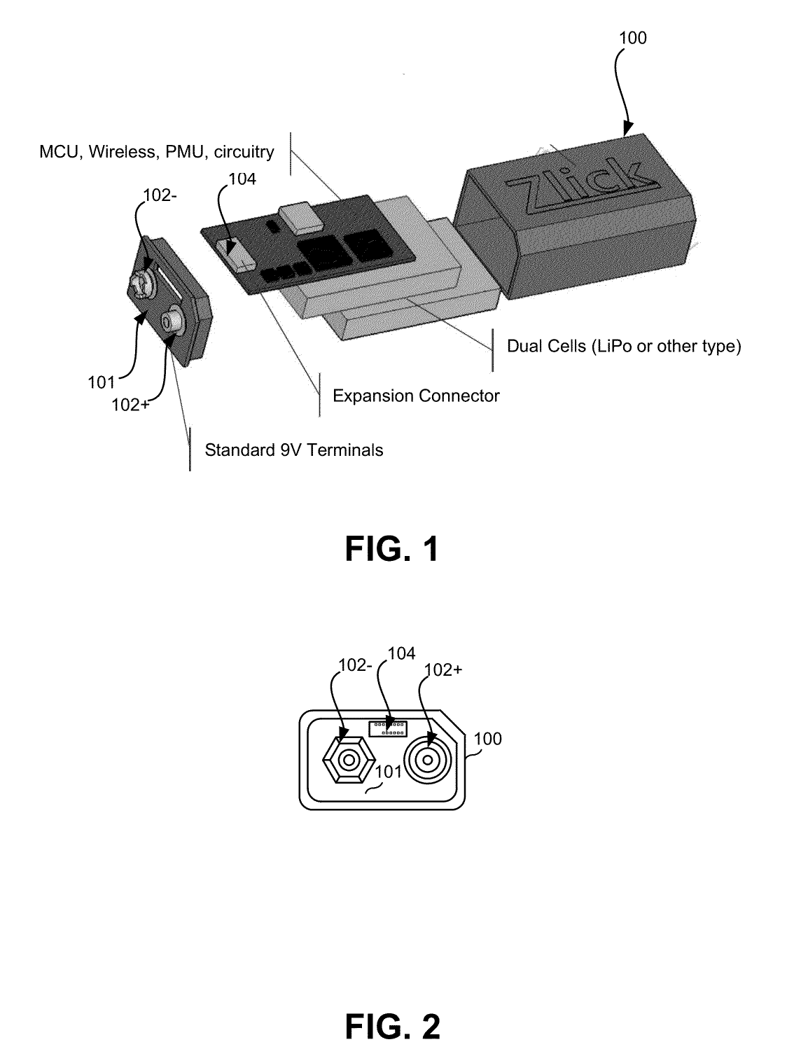

FIG. 1 is an illustration of a battery casing 100. Battery casing 100 can house a power source, such as a compact 9 V, 5 V, or other voltage battery, often in a form factor that is compatible with other battery standards, but that is not required. Battery casing 100 also houses some processing capability, such as circuitry or a programmed microprocessor or microcontroller, as well as some communication capability, such as wireless communication capability.

FIG. 1 shows some features of battery casing 100, such as a top surface 101 providing access to a positive battery terminal 102+, a negative battery terminal 102−, and an expansion connector 104. In a preferred embodiment, battery casing 100 is usable as a replacement for a battery in a device that has a need for added communication capability and as such, positive battery terminal 102+ and a negative battery terminal 102− might be configured or arranged to be in a standardized position or location and provide thereon electrical power. In a specific embodiment, positive battery terminal 102+ and negative battery terminal 102− together supply a current to a device when attached to terminals 102, wherein positive battery terminal 102+ provides a more positive voltage relative to negative battery terminal 102−, such as 7V to 9V nominal, with positive battery terminal 102+ having a shape that would accept a connector having the shape of negative battery terminal 102− and vice versa.

FIG. 2 provides a top view of battery casing 100, showing the features that appear on top surface 101. The spatial relationship between positive battery terminal 102+ and negative battery terminal 102− might be in compliance with standards for 9V batteries.

Expansion connector 104 might provide for two, four, eight, or some other number of wired connections. In the preferred embodiment, expansion connector 104 is a female connector and its border does not extend beyond surface 101 so far as to interfere with a connection to terminals 102. Expansion connector 104 might include a multi-pin miniature electrical connector, located between or aside battery terminals 102. This connector provides access to a regulated supply and interfaces to an integrated micro-controller.

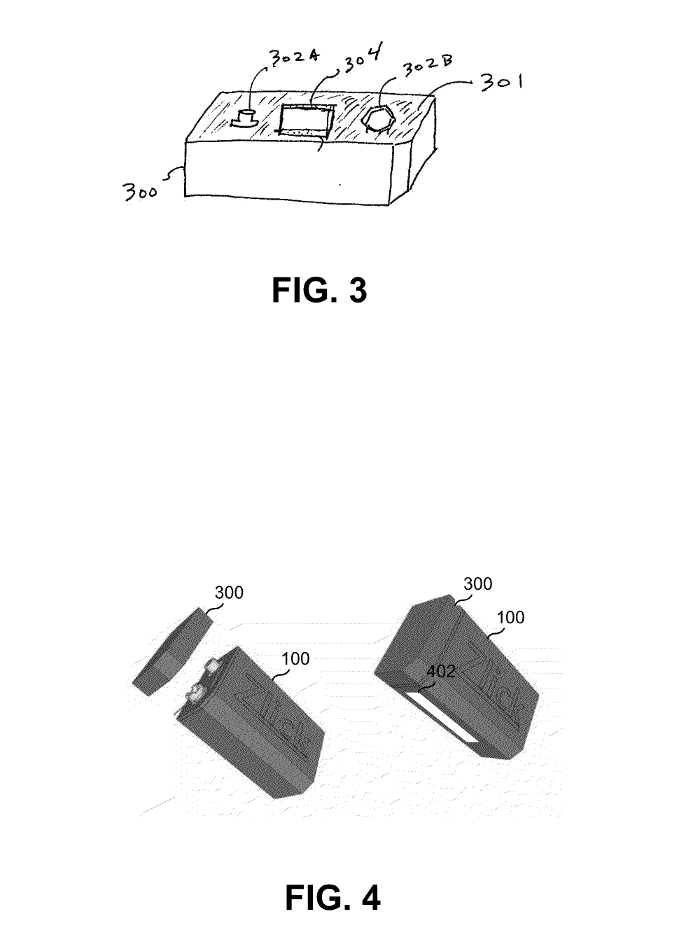

FIG. 3 illustrates an expansion tab 300 as might be used with battery casing 100. Expansion tab 300 is shown with having a surface 301 through which is exposed mechanical posts 302A and 302B, and an expansion tab connector 304. In the preferred embodiment, expansion tab connector 304 is a male connector and is shaped such that the wires of expansion tab connector 304 make contact with the wires of expansion connector 104 when expansion tab 300 is mechanically attached to battery casing 100.

In a preferred embodiment, mechanical posts 302A and 302B mechanically connect to battery terminals 102 in order to support expansion tab 300 and maintain mechanical coupling with battery casing 100, while power, control and data signals are conveyed by the electrical connections provided via expansion connector 104 and expansion tab connector 304. Mechanical posts 302A and 302B need not be made of conducting material, but should be made of material sufficient to support expansion tab 300 and maintain the electrical connections for connector 104 and expansion tab connector 304.

Expansion tabs could be used in applications such as detecting motion, temperature and humidity monitoring, etc. The expansion tabs might have small housings containing additional sensors and circuitry. Once connected, the battery housing controller might identify the particular expansion tab (serial number, type, etc.) connected and install the appropriate device driver. If the appropriate driver is not available, the controller might download it from the cloud. Once installed, a server on the cloud is notified of the new functionality and the smartphone apps that handle the features of those expansion tabs are also notified. The app might present options to the user for device configuration and notification (e.g., what to notify, how often to check, limits, etc.).

FIG. 4 shows a battery casing and expansion tab coupled. The coupled unit might include some other attachment means, such as one half of a hook-and-loop fabric fastener, a fastener hole, such as a nail hole or screw hole, or adhesive means, such as tape, glue or other adhesive material applied to the battery casing or the expansion tab, or both. An example is double-sided tape 402. Those attachment means might allow the coupled unit to be easily installed where appropriate or needed for the type of expansion tab used.

Examples of sensors that might be used in expansion tabs include accelerometers, motion sensors, tilt sensors, temperature sensors, light sensors, or other compact sensors. For example, a coupled using comprising a tilt sensor and a battery casing might be nailed to the inside of a cabinet door that is hinged from above or below. Installed in that way, the tilt sensor would sense the cabinet door being opened or closed. Sensing signals can be sent to a processor within the battery casing and from there a wireless signal can be sent to a wireless network so that the fact that the cabinet door was opened or closed could be conveyed to an application that is monitoring signals related to this coupled unit or other coupled units.

A specific implementation might be a drug cabinet in a hospital that is not already equipped with sensors and communication capability. Suppose a tilt sensor coupled unit (battery casing and expansion tab) are attached to a drug cabinet hinged from above. If the drug cabinet is opened (by swinging the door rotating forward and up, the tilt sensor senses that, signals the processor, the processor causes a message to be sent over the wireless network and that is routed (according to a routing protocol or per addressing information added by the processor) to a server that then sends an alarm message to an application running on an administrator's smartphone.

In another example, the expansion tab is a temperature sensor and the coupled unit is used as part of a wireless thermostat that can be placed in desired locations and will signal to a server a current temperature, which the server can use to control heating/cooling devices accordingly.

On a conventional 9V battery, there are two connectors, one each for the anode and cathode. These connectors are used to electrically connect the battery to the electrical circuit. In addition to their electrical properties, these connectors also have a mechanical connection element, providing a snap fit with a mating connector. This can be used to maintain mechanical coupling with the expansion tabs even without providing electrical connections. This adds flexibility in that the expansion tab does not have to deal with only 9 volts. The expansion connector might supply a regulated output at some other voltage or a regulated 9 volts.

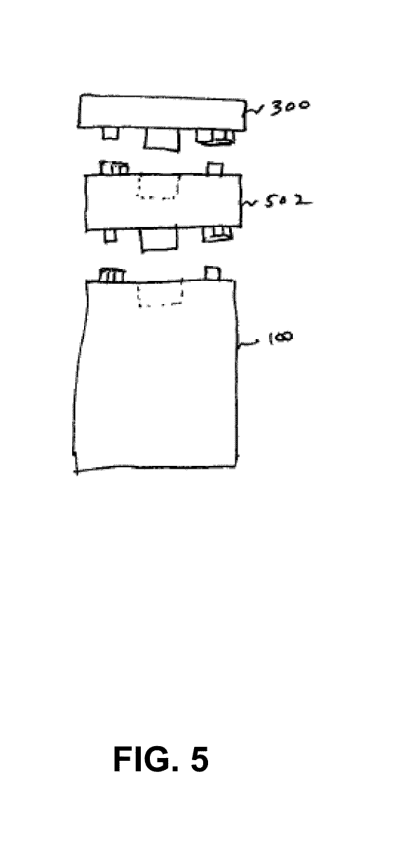

FIG. 5 illustrates stackable expansion tabs, wherein at least one of the expansion tabs 502 has suitable mechanical and electrical connectors on a top face and an opposite face, thereby allowing for stacks of two or more expansion tabs to be provided. In this manner, expansion tabs can be “daisy-chained.”

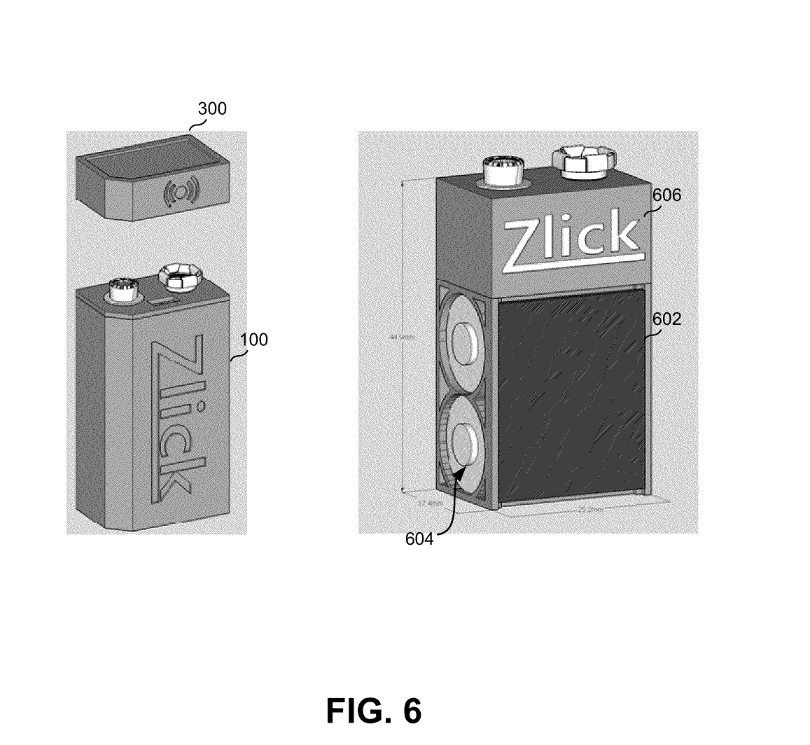

FIG. 6 illustrates various alternate form factors for battery casings. In the example shown in FIG. 1, the form factor was the same as a conventional 9V battery with a side notch that can be used to control positioning and usability in various applications. The expansion tab then connects on top of the battery casing, creating a stand-alone sensor platform. This is also illustrated on the left in FIG. 6, as battery casing 100 and expansion tab 300.

In an alternative approach, a smaller form factor is used, wherein the coupled unit is powered by a battery having two V2 AA cells (604) and the battery housing also includes an RF and/or processor board 602, so that with the addition of an expansion tab 606, the coupled unit is still within the form factor of a conventional 9V battery.

One type of expansion tab could be a 9V battery extension that includes a boost regulator and 9V terminals. This would then allow the coupled unit to be considerably more compact in the standalone sensor mode, as well as reducing system cost by removing the need to have three connectors on top of the wireless and power module and the boost circuit for the battery terminal voltage. In other variations, a different type of regulator might be used.

Expansion tabs might be provided for microswitch detection, an optical sensor that can distinguish an open door and a closed door based on differences of light falling on the optical sensor, or other sensors.

Other examples where the communications elements might find usefulness include gas/water/fire sensors, garage door open/closed sensors, door opening (e.g., front door, medicine or liquor cabinet door) sensors, temperature sensors, and the like. Because the expansion tabs are interchangeable, a very flexible sensor network can be implemented using these devices.

In some sensor networks, other data is taken into account. For example, a sensor might be employed onto a door that should not be opened if person A is not within range of that door. An alarm app would then send an alarm to person A's smartphone if the external information indicates that person A is out of range and not send an alarm if person A is determined to be within range. The external information might be provided as a form of geofencing.

Many other scenarios can be supported by the sensor network. For example, hours of operation might be included in the other data taken into account. This might allow for selective notification, such as where a user chooses to only be notified if the door is opened during a particular time-frame, e.g., while they are out of the house at work.

The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

Further embodiments can be envisioned to one of ordinary skill in the art after reading this disclosure. In other embodiments, combinations or sub-combinations of the above-disclosed invention can be advantageously made. The example arrangements of components are shown for purposes of illustration and it should be understood that combinations, additions, re-arrangements, and the like are contemplated in alternative embodiments of the present invention. Thus, while the invention has been described with respect to exemplary embodiments, one skilled in the art will recognize that numerous modifications are possible.

For example, the processes described herein may be implemented using hardware components, software components, and/or any combination thereof. The specification and drawings are, accordingly, to be regarded in an illustrative rather than a restrictive sense. It will, however, be evident that various modifications and changes may be made thereunto without departing from the broader spirit and scope of the invention as set forth in the claims and that the invention is intended to cover all modifications and equivalents within the scope of the following claims.

All references, including publications, patent applications, and patents, cited herein are hereby incorporated by reference to the same extent as if each reference were individually and specifically indicated to be incorporated by reference and were set forth in its entirety herein.

What is claimed is:

1. A sensor element comprising:
mechanical connectors adapted to couple to conventional battery electrical terminals to provide mechanical support for the sensor on a battery housing or device;
at least one sensing element that is capable of emitting an electrical signal upon sensing an sensed environmental variable; and
an electrical connector, distinct from the mechanical connectors for receiving power from, and sending signals to, the battery housing or device.

2. The sensor of claim 1, wherein the battery housing or device is a battery with communication capability.

3. The sensor of claim 1, wherein the power received from the battery housing or device is at a voltage other than a voltage supplied at the conventional battery electrical terminals.

4. A sensor network comprising:
at least one sensor element comprising:
a) mechanical connectors adapted to couple to conventional battery electrical terminals to provide mechanical support for the sensor on a battery housing or device;
b) at least one sensing element that is capable of emitting an electrical signal upon sensing an sensed environmental variable; and
c) an electrical connector, distinct from the mechanical connectors for receiving power from, and sending signals to, the battery housing or device;
a communications hub, that receives and processes messages received from the at least one sensor element;
an external information source;
a processor that evaluates the messages and information from the external information source; and
a user interface that shows display data filtered by at least some of the information from the external information source.

5. The sensor network of claim 4, wherein the information from the external information source includes user presence information, such that the display data varies based on presence of predetermined users.
